(19) United States
(12) Patent Application Publication
(10) Pub. No.: US 2026/0323506 A1
(43) Pub. Date: Oct. 15, 2026

(54) METHOD FOR LOW-LATENCY SERVICE TRANSMISSION AND ELECTRONIC DEVICE

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 19/485,651

(22) PCT Filed: May 19, 2023
(86) PCT No.: PCT/CN2023/095390

§ 371 Date: Nov. 18, 2025

(51) Int. Cl. H04W 52/02

(52) U.S. Cl. CPC H04W 52/0206

(57) ABSTRACT

The present disclosure provides a method for low-latency service transmission, an apparatus, a device, and a storage medium. The method is applied to a first AP and includes: determining a second R-TWT SP according to a first R-TWT SP of a neighboring AP; sending a first frame, where the first frame includes the first R-TWT SP and the second R-TWT SP, and the first frame indicates that the low-latency service transmission is performed within the second R-TWT SP according to the first R-TWT SP.

### CROSS-REFERENCE TO RELATED APPLICATION

The present application is a U.S. National Stage of International Application No. PCT/CN2023/095390, filed on May 19, 2023, the entire contents of which are incorporated herein by reference for all purposes.

### TECHNICAL FIELD

The present disclosure relates to a field of communication technology, and more particularly, to a method for low-latency service transmission, an apparatus, a device, and a storage medium.

### BACKGROUND

With continuous development of Wireless Fidelity (Wi-Fi) technology, researchers have proposed the next-generation Wi-Fi technology: Ultra High Reliability (UHR), which aims to improve the reliability of WLAN connections, reduce latency, increase manageability, and enhance throughput and the like.

In the aforementioned UHR architecture, an Access Point (AP) may broadcast its own Restricted Target Wake Time Service Period (R-TWT SP), such that a Station (STA) joins the R-TWT SP of the AP for low-latency service transmission. However, the existing standards only specify how the AP and its associated STA perform the low-latency service transmission after the AP broadcasts its own R-TWT SP, and there is currently no solution for how an AP, after acquiring the R-TWT SP shared by a neighboring AP, instructs the STA to perform the low-latency service transmission.

### SUMMARY

A first aspect of the present disclosure provides a method for low-latency service transmission applicable to a first AP, and the method includes:
determining a second R-TWT SP according to a first Restricted Target Wake Time Service Period (R-TWT SP) of a neighboring AP;
sending a first frame, where the first frame includes the first R-TWT SP and the second R-TWT SP, and the first frame indicates that the low-latency service transmission is performed within the second R-TWT SP according to the first R-TWT SP.

A second aspect of the present disclosure provides a method for low-latency service transmission applicable to a first STA, and the method includes:
receiving a first frame, where the first frame includes a first R-TWT SP of a neighboring AP of a first AP and a second R-TWT SP of the first AP, the second R-TWT SP is determined by the first AP according to the first R-TWT SP, and the first frame indicates that low-latency service transmission is performed within the second R-TWT SP according to the first R-TWT SP.

A third aspect of the present disclosure further provides an electronic device, including a memory, a processor, and a computer program stored in the memory and executable on the processor, where the processor, when executing the program, implements any of the method for low-latency service transmission provided in the present disclosure.

The additional aspects and advantages of the present disclosure will be partially described below, and these will become apparent from the following description or through the practice of the present disclosure.

### BRIEF DESCRIPTION OF THE DRAWINGS

To better illustrate technical solutions of the embodiments of the present disclosure, a brief introduction to the drawings used in the description of the embodiments of the present disclosure is provided below. It is obvious that the drawings described below are only some embodiments of the present disclosure. For those skilled in the art, without inventive effort, other drawings may be obtained according to these drawings.

FIG. 1 is a schematic diagram of a structure of a communication system provided by the embodiments of the present disclosure;

FIG. 2 is a schematic diagram of interactions of a method for low-latency service transmission provided by embodiments of the present disclosure;

FIG. 3 is a flowchart of a method for low-latency service transmission provided by embodiments of the present disclosure;

FIG. 4 is another flowchart of a method for low-latency service transmission provided by embodiments of the present disclosure;

FIG. 5 is a schematic diagram of a structure of an apparatus for low-latency service transmission provided by embodiments of the present disclosure;

FIG. 6 is another schematic diagram of a structure of an apparatus for low-latency service transmission provided by embodiments of the present disclosure;

FIG. 7 is a schematic diagram of a structure of an electronic device provided by embodiments of the present disclosure.

### DETAILED DESCRIPTION

The term “and/or” in the embodiments of the present disclosure describes the relationship between associated objects, indicating that three relationships may exist, for example, A and/or B, which may represent: A existing alone, A and B existing simultaneously, or B existing alone. The character “/” generally indicates that the associated objects before and after the slash are in an “or” relationship.

The term “a plurality of” in the embodiments of the present disclosure refers to two or more, and other quantifiers are similar.

Here, exemplary embodiments are described in detail, with the examples being shown in the drawings. Unless otherwise indicated, the same reference numerals in the different drawings represent the same or similar elements. The embodiments described in the following exemplary embodiments do not represent all possible embodiments consistent with the invention. Instead, they are only examples of devices and methods that are consistent with some aspects of the present invention as detailed in the accompanying claims.

The terms used in the present disclosure are for the purpose of describing specific embodiments only and are not intended to limit the present disclosure. The singular forms “a”, “said”, and “the” used in the present disclosure and the accompanying claims are intended to include the plural forms, unless the context clearly indicates otherwise. It should also be understood that the term “and/or” used herein refers to any or all possible combinations of the listed items being associated.

It should be understood that although the terms “first”, “second”, “third”, and so on may be used in the present disclosure to describe various information, these terms are not limited to these specific terms. These terms are merely used to distinguish similar types of information from each other. For example, without departing from the scope of the present disclosure, “first information” may also be referred to as “second information”, and similarly, “second information” may also be referred to as “first information”. Depending on the context, the word “if” used here may be interpreted as “when”, “upon”, or “in response to determining”.

In the existing Wi-Fi 7 (IEEE 802.11be) architecture, the R-TWT mechanism is defined to transmit low-latency services, that is, the AP broadcasts the R-TWT SP of the AP, and the STA device that is associated with the AP and join the R-TWT SP may perform the low-latency service transmission with the AP within the R-TWT SP.

In the existing IEEE 802.11be, when the R-TWT SP starts, a member STA that joins the R-TWT SP may suspend the decrementing of the backoff counter for any access category (AC) that has no R-TWT Traffic Identifier (TID) mapped to it, until the STA has delivered all of its frames from the R-TWT TID, and the decrementing of the backoff counter is resumed after that, or when the SP ends.

When a STA, which is affiliated with a Non-AP Multi-Link Device (MLD) and operates on one of a pair of Non-Simultaneous Transmit and Receive (NSTR) or Enhanced Multi-Link Single Radio (EMLSR) or Enhanced Multi-Link Multi Radio (EMLMR) links, is a member of the R-TWT SP on the first link, if the second STA, which is affiliated with the same Non-AP MLD, is not a member of any other R-TWT SP on the second link that overlaps with the above R-TWT SP, then, if both the second STA and its associated AP (referred to as the second AP) have their dot11RestrictedTWTOptionImplemented set to true, they should follow the rules below:
the second AP, as the Transmission Opportunity (TXOP) holder on the second link, should ensure that its TXOP ends no later than T amount of time before the start time of the R-TWT SP on the first link;
the second STA, as a TXOP holder on the second link, should ensure that its TXOP ends no later than T amount of time before the start time of the R-TWT SP on the first link;
where T equals one of the following values:
if the two STAs operate on a pair of NSTR links, T is 0;
if the two STAs belong to a pair of Enhanced Multi-Link Single Radio (EMLSR) links, T is an EMLSR transition delay indicated in the EMLSR Transition Delay subfield;

If the two STAs belong to a pair of Enhanced Multi-Link Multi-Radio (EMLMR) links, T is an EMLMR delay indicated in the EMLMR Delay subfield.

However, the existing standards only specify how the AP and its associated STAs perform the low-latency service transmission after the AP broadcasts its own R-TWT SP. However, after the AP acquires the R-TWT SP shared by a neighboring AP, there is currently no solution to how the AP should instruct the STA to perform the low-latency service transmission, and how the AP and STA should perform the low-latency service transmission.

To solve the above problems, the technical solutions of the embodiments of the present disclosure will be clearly and fully described below with reference to the accompanying drawings of the present disclosure. Obviously, the described embodiments are only part of the embodiments of the present disclosure, not all the embodiments. All other embodiments that may be obtained by those skilled in the art without creative labor according to the embodiments of the present disclosure fall within the scope of protection of the present disclosure.

The method and apparatus are based on the same disclosed concept. Since the principles for solving the problems in the method and apparatus are similar, the implementations of the apparatus and method may refer to each other, and the repeated details will not be elaborated.

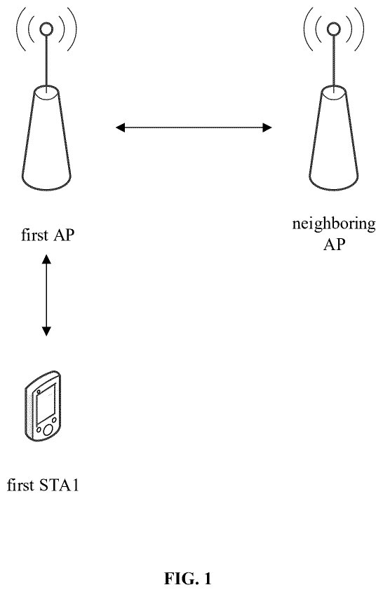

Referring to FIG. 1, FIG. 1 is a schematic diagram of a structure of a communication system provided by the embodiments of the present disclosure. The system architecture includes a first AP, a neighboring AP, and a first STA. The first STA is associated with the first AP.

The neighboring AP may share the first R-TWT SP of the neighboring AP with the first AP, and the first AP determines the second R-TWT SP of the first AP according to the first R-TWT SP of the neighboring AP.

Further, the first AP may determine and send the first frame to the STA, where the first frame includes the second R-TWT SP of the first AP and the first R-TWT SP of the neighboring AP, and the first frame indicates the first STA to perform the low-latency service transmission within the second R-TWT SP according to the first R-TWT SP.

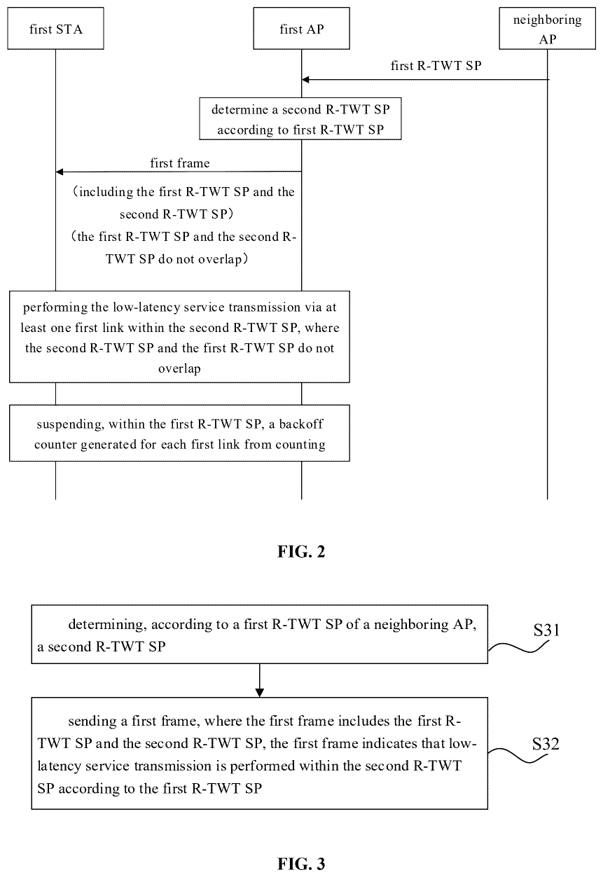

The method for low-latency service transmission provided in the disclosed embodiments will be summarized with reference to FIG. 2. As shown in FIG. 2, the first AP may acquire a first R-TWT SP of a neighboring AP. After the first AP acquires the first R-TWT SP of the neighboring AP, the first AP may plan its own R-TWT SP according to the first R-TWT SP shared by the neighboring AP, i.e., determining a second R-TWT SP of the first AP, and the first R-TWT SP and the second R-TWT SP do not overlap.

Further, the first AP determines and sends the first frame to the first STA. The first frame includes the first R-TWT SP and the second R-TWT SP, and the first frame indicates the first STA to perform the low-latency service transmission within the second R-TWT SP according to the first R-TWT SP.

The first frame may be a beacon frame, a probe response frame, or an association response frame sent in response to the STA, which is not limited herein.

The first AP and the neighboring AP may be independent APs or may be an AP MLD, which is not limited herein. The first STA may be an independent STA that is not affiliated with any Non-AP MLD, or an affiliate STA of a Non-AP MLD, or a Non-AP MLD, which is not limited herein.

For the first AP or first STA, the first AP or first STA may perform the low-latency service transmission within the second R-TWT SP via at least one first link according to the first R-TWT SP of the neighboring AP.

In a case that the first AP is an independent AP and the first STA is an independent STA, an affiliate STA of a Non-AP MLD, or a Non-AP MLD, the first AP and the first STA are associated through one communication link. The first AP and the first STA may perform the low-latency service transmission within the second R-TWT SP through this communication link.

In a case that the first AP is an AP MLD and the first STA is an independent STA or an affiliate STA of a Non-AP MLD, the first AP and the first STA are associated through one communication link. The first AP and the first STA may perform the low-latency service transmission within the second R-TWT SP through this communication link.

In a case that the first AP is an AP MLD and the first STA is a Non-AP MLD, the first AP and the first STA may be associated through at least one communication link. The first AP and the first STA may perform the low-latency service transmission within the second R-TWT SP through at least one of these communication links.

The communication link used by the first AP and the first STA for the low-latency service transmission within the second R-TWT SP is the first link.

The communication link supported by the first R-TWT SP for the low-latency service transmission is the second link. When the first R-TWT SP is applied to a single link, the first R-TWT SP supports one second link for the low-latency service transmission. When the first R-TWT SP is applied to multiple links, the first R-TWT SP supports a plurality of second communication links for the low-latency service transmission.

For any first link used by the first AP and the first STA for the low-latency service transmission within the second R-TWT SP, if the first link is the same as any second link supported by the first R-TWT SP for the low-latency service transmission, or if they are NSTR links, eMLSR links, or eMLMR links, since the first R-TWT SP and the second R-TWT SP do not overlap, the first AP and the first STA terminate the low-latency service transmission before the first R-TWT SP arrives.

Within the first R-TWT SP, the first AP or first STA suspends the counting of the backoff counter generated by each first link. If the first AP and the first STA are associated through a plurality of communication links, then, within the first R-TWT SP, when the first AP or the first STA performs the low-latency service transmission through each first link, for the communication links between the first AP and the first STA, where any third link is a NSTR link, an eMLSR link, or an eMLMR link with each first link, the first AP or the first STA also suspend the counting of the backoff counter generated by each third link within the first R-TWT SP.

When the first R-TWT SP supports a plurality of communication links for the low-latency service transmission, the first AP may acquire service-to-link (TID-to-link) mapping information corresponding to the first R-TWT SP from the neighboring AP, and the first STA may acquire the TID-to-link mapping information corresponding to the first R-TWT SP from the first AP. The first AP or the first STA may use the TID-to-link mapping information corresponding to the first R-TWT SP to determine the plurality of second links supported by the first R-TWT SP for low-latency service transmission.

When the first AP acquires the first R-TWT SP from the neighboring AP, an information field carrying the first R-TWT SP also includes an aligned field, when a value of the aligned field is 1 (first indication information), it is used to indicate that the first R-TWT SP supports the plurality of communication links for the low-latency service transmission.

When the first R-TWT SP supports a plurality of communication links for the low-latency service transmission, the information field of the first frame used to carry the first R-TWT SP also includes an aligned field, and when the value of the aligned field is 1 (first indication information), it is used to indicate that the first R-TWT SP supports the plurality of communication links for the low-latency service transmission.

When the second R-TWT SP supports a plurality of communication links for the low-latency service transmission, the information field of the first frame used to carry the second R-TWT SP also includes an aligned field, and when the value of the aligned field is 1 (second indication information), it is used to indicate that the second R-TWT SP supports the plurality of communication links for the low-latency service transmission.

The embodiments of the present disclosure provide a method for low-latency service transmission, which may be applied to the first AP. For details, refer to FIG. 3, which is a flowchart of the method for the low-latency service transmission provided by the embodiments of the present disclosure.

In some embodiments, the method may include the following steps S31-S32:
step S31: a second R-TWT SP is determined according to a first R-TWT SP of a neighboring AP.

The first AP may directly acquire the first R-TWT SP shared by the neighboring AP, or may acquire the first R-TWT SP that is shared by the neighboring AP to another AP from the another AP.

As an example, the first AP may listen to the broadcast of the neighboring AP to acquire the first R-TWT SP shared by the neighboring AP according to the broadcast of the neighboring AP.

As an example, the second AP may listen to the broadcast of the neighboring AP to acquire the first R-TWT SP shared by the neighboring AP according to the broadcast of the neighboring AP. The first AP may listen to the broadcast of the second AP to acquire the first AP shared by the neighboring AP from the broadcast of the second AP, and simultaneously acquire the R-TWT SP of the second AP.

After the first AP acquires the first R-TWT SP of the neighboring AP, the first AP may plan its own R-TWT SP according to the first R-TWT SP shared by the neighboring AP, i.e., determining the second R-TWT SP of the first AP.
step S32: a first frame is sent, where the first frame includes the first R-TWT SP and the second R-TWT SP, and the first frame indicates that the low-latency service transmission is performed within the second R-TWT SP according to the first R-TWT SP.

After determining the second R-TWT SP of the first AP, the first AP may determine and send the first frame.

The first frame includes the second R-TWT SP of the first AP and the first R-TWT SP of the neighboring AP, and the first frame indicates that the low-latency service transmission is performed within the second R-TWT SP according to the first R-TWT SP of the neighboring AP.

In some embodiments, the first frame may be a beacon frame, a probe response frame, or an association response frame sent in response to the STA, which is not limited herein.

In the method for the low-latency service transmission applied to the first AP provided by the embodiments of the present disclosure, the method also includes:
performing the low-latency service transmission via at least one first link within the second R-TWT SP according to the first R-TWT SP of the neighboring AP.

The second R-TWT SP and the first R-TWT SP do not overlap.

The first AP and the neighboring AP may be independent APs or an AP MLD, which is not limited herein. The first STA may be an independent STA not affiliated with any Non-AP MLD, or an affiliate STA of a Non-AP MLD, or a Non-AP MLD itself, which is not limited herein.

Specifically, the first AP may perform the low-latency service transmission via at least one first link within the second R-TWT SP according to the second link supported by the first R-TWT SP for the low-latency service transmission.

In a case that the first AP is an independent AP, and the first STA is an independent STA, an affiliate STA of a Non-AP MLD, or a Non-AP MLD, the first AP and the first STA are associated through one communication link. The first AP and the first STA may perform the low-latency service transmission within the second R-TWT SP through this communication link.

In a case that the first AP is an AP MLD, and the first STA is an independent STA or an affiliate STA of a Non-AP MLD, the first AP and the first STA are associated through one communication link. The first AP and the first STA may perform the low-latency service transmission within the second R-TWT SP through this communication link.

When the first AP is an AP MLD, and the first STA is a Non-AP MLD, the first AP and the first STA may be associated through at least one communication link. The first AP and the first STA may perform the low-latency service transmission within the second R-TWT SP through at least one of these communication links.

The communication link used by the first AP and the first STA for the low-latency service transmission within the second R-TWT SP is the first link.

In the method for the low-latency service transmission applied to the first AP provided by the embodiments of the present disclosure, each first link used by the first AP for the low-latency service transmission is either any communication link from at least one second link, or a Non-Simultaneous Transmit and Receive (NSTR) link, eMLSR link, or eMLMR link with any second link.

Each second link is the communication link supported by the first R-TWT SP for the low-latency service transmission. The communication link supported by the first R-TWT SP for the low-latency service transmission is the second link. When the first R-TWT SP is applied to a single link, the first R-TWT SP supports one second link for the low-latency service transmission. When the first R-TWT SP is applied to multiple links, the first R-TWT SP supports a plurality of second communication links for the low-latency service transmission.

In some embodiments, each first link may also be any other communication link except for each second link.

For example, if the communication links supported by the first R-TWT SP for the low-latency service transmission are link1, link2, and link3, for any first link, the first link may be any one of link1, link2, or link3, or any other link except for link1, link2, and link3, or link4 (where link4 is the NSTR link, eMLSR link, or eMLMR link with any second link of link1, link2, or link3).

Based on this, the first AP may perform the low-latency service transmission within the second R-TWT SP through at least one first link.

As an example, when the first R-TWT SP supports one communication link for the low-latency service transmission, i.e., in a case that the first R-TWT SP is applied to a single link, when the first AP performs low-latency service transmission through the communication link, since the first R-TWT SP and the second R-TWT SP do not overlap, the first AP may transmit the low-latency service before the first R-TWT SP starts through the communication link.

As an example, when the first R-TWT SP supports the plurality of communication links (assuming link5 and link6) for the low-latency service transmission, i.e., in a case that the first R-TWT SP is applied to multiple links, when the communication link associated with the first AP does not include the communication link that is a NSTR link with link5, and the first AP performs the low-latency service transmission through link5, since the first R-TWT SP and the second R-TWT SP do not overlap, the first AP may transmit the low-latency service through link5 before the first R-TWT SP starts.

When there is a communication link (such as link 7) that is a NSTR link with link 6 in the communication link associated with the first AP, and the first AP performs the low-latency service transmission through link 7, since the first R-TWT SP and the second R-TWT SP do not overlap, the first AP may transmit the low-latency service through link 7 before the start of the first R-TWT SP, thus avoiding interference with the low-latency service transmission on link 6 of the neighboring AP when transmitting the low-latency service through link 7 within the first R-TWT SP.

In the method for the low-latency service transmission applied to the first AP provided by the embodiments of the present disclosure, when the first R-TWT SP supports the plurality of communication links for the low-latency service transmission, the method further includes:
acquiring service-to-link (TID-to-link) mapping information corresponding to the first R-TWT SP from the neighboring AP;
determining a plurality of second links supported by the first R-TWT SP for the low-latency service transmission according to the TID-to-link mapping information corresponding to the first R-TWT SP.

The first AP may determine the communication link corresponding to the low-latency service transmission supported by the first R-TWT SP according to the TID-to-link mapping information corresponding to the first R-TWT SP, and determine it as the second link for the low-latency service transmission supported by the first R-TWT SP.

When the first AP acquires the first R-TWT SP of the neighboring AP, the information field carrying the first R-TWT SP also includes first indication information, where the first indication information indicates that the first R-TWT SP supports the plurality of communication links for the low-latency service transmission.

For example, the information field carrying the first R-TWT SP may also include an aligned field, when a value of the aligned field is 1 (first indication information), it indicates that the first R-TWT SP supports the plurality of communication links for the low-latency service transmission.

In some embodiments, after the neighboring AP shares the first R-TWT SP, the neighboring AP may also send the first indication information to the first AP, which indicates that the first R-TWT SP supports the plurality of communication links for the low-latency service transmission. The manner by which the first AP acquires the first indication information is the same as the manner by which the first AP acquires the first R-TWT SP from the neighboring AP.

In a case that the first AP receives the first indication information, the first AP acquires the TID-to-link mapping information corresponding to the first R-TWT SP from the neighboring AP. In some embodiments, the information field used to carry the first R-TWT SP may include the Traffic Identifier-to-Link Mapping (TID-to-link mapping) information corresponding to the first R-TWT SP, where the first AP, when acquiring the first R-TWT SP from the neighboring AP, may also acquire the TID-to-link mapping information corresponding to the first R-TWT SP simultaneously.

In the method for the low-latency service transmission applied to the first AP provided by the embodiments of the present disclosure, when the first R-TWT SP supports the plurality of communication links for the low-latency service transmission, the first frame also includes first indication information, where the first indication information indicates that the first R-TWT SP supports the plurality of communication links for the low-latency service transmission.

When the second R-TWT SP supports the plurality of communication links for the low-latency service transmission, the first frame also includes second indication information, where the second indication information indicates that the second R-TWT SP supports the plurality of communication links for the low-latency service transmission.

The information field, used to carry the first R-TWT SP, of the first frame also includes first indication information, the first indication information indicates that the first R-TWT SP supports the plurality of communication links for the low-latency service transmission. For example, the information field used to carry the first R-TWT SP may also include an aligned field, when the value of the aligned field is 1 (first indication information), it's used to indicate that the first R-TWT SP supports the plurality of communication links for the low-latency service transmission.

Similarly, the information field, used to carry the second R-TWT SP, of the first frame also includes second indication information, the second indication information indicates that the second R-TWT SP supports the plurality of communication links for the low-latency service transmission. For example, the information field used to carry the second R-TWT SP may also include an aligned field, when the value of the aligned field is 1 (second indication information), it is used to indicate that the second R-TWT SP supports the plurality of communication links for the low-latency service transmission.

Based on this, the first AP may also indicate through the first frame whether the first R-TWT SP and the second R-TWT SP support the plurality of communication links for the low-latency service transmission to the STA.

In the method for the low-latency service transmission applied to the first AP provided by the embodiments of the present disclosure, it further includes:
suspending, within the first R-TWT SP, a backoff counter generated by each first link from counting.

That is, within the first R-TWT SP, the first AP does not decrement the number of the backoff counter generated by each first link, to indicate that each first link is in a busy state.

In some embodiments, for each first link, when the first AP performs the low-latency service transmission through the first link within the first R-TWT SP, the first AP also suspends the counting of the backoff counter generated by the third link, which is the NSTR link, eMLSR link, or eMLMR link with the first link, within the first R-TWT SP.

In some embodiments, the first AP may also suspend the counting of the backoff counter generated by each first link within the second R-TWT SP.

As an example, for any first link used by the first AP and first STA for the low-latency service transmission within the second R-TWT SP, if the first link is the same as any second link supported by the first R-TWT SP for the low-latency service transmission, or is a NSTR link, eMLSR link, or eMLMR link with the second link, and since the first R-TWT SP and second R-TWT SP do not overlap, the first AP terminates the low-latency service transmission before the first R-TWT SP arrives.

Within the first R-TWT SP, the first AP suspends the counting of the backoff counter generated by each first link. If the first AP and the first STA are associated through a plurality of communication links, then, within the first R-TWT SP, when the first AP performs the low-latency service transmission through each first link, the first AP also suspends the counting of the backoff counter generated by each third link in the communication links between the first AP and the first STA, and the third link is a NSTR link, eMLSR link, or eMLMR link with each first link.

The embodiments of the present disclosure provide a method for the low-latency service transmission, which may be applied to the first STA. For details, refer to FIG. 4, G. 4 is a flowchart of the method for the low-latency service transmission provided by the embodiments of the present disclosure.

In some embodiments, the method may include the following step S41:
step S41: a first frame is received, where the first frame includes a first R-TWT SP of a neighboring AP of a first AP and a second R-TWT SP of the first AP, the second R-TWT SP is determined by the first AP according to the first R-TWT SP. The first frame indicates that low-latency service transmission is performed within the second R-TWT SP according to the first R-TWT SP.

The first AP may directly acquire the first R-TWT SP shared by the neighboring AP, or may acquire the first R-TWT SP that is shared by the neighboring AP to another AP from the another AP.

As an example, the first AP may listen to the broadcast of the neighboring AP to acquire the first R-TWT SP shared by the neighboring AP according to the broadcast of the neighboring AP.

As an example, the second AP may listen to the broadcast of the neighboring AP to acquire the first R-TWT SP shared by the neighboring AP according to the broadcast of the neighboring AP. The first AP may listen to the broadcast of the second AP to acquire the first AP shared by the neighboring AP from the broadcast of the second AP, and simultaneously acquire the R-TWT SP of the second AP.

After the first AP acquires the first R-TWT SP of the neighboring AP, the first AP may plan its own R-TWT SP according to the first R-TWT SP shared by the neighboring AP, i.e., determining the second R-TWT SP of the first AP.

After determining the second R-TWT SP of the first AP, the first AP may determine and send the first frame.

The first frame includes the second R-TWT SP of the first AP and the first R-TWT SP of the neighboring AP, and the first frame indicates that the low-latency service transmission is performed within the second R-TWT SP according to the first R-TWT SP of the neighboring AP.

In some embodiments, the first frame may be a beacon frame, a probe response frame, or an association response frame sent in response to the STA, which is not limited herein.

The first AP and the neighboring AP may be independent APs or an AP MLD, which is not limited herein.

The first STA is associated with the first AP and may be an independent STA not affiliated with any Non-AP MLD, an affiliate STA of a Non-AP MLD, or a Non-AP MLD, which is not limited herein.

In the method for the low-latency service transmission applied to the first STA provided by the embodiments of the present disclosure, the method further includes:
performing the low-latency service transmission via at least one first link within the second R-TWT SP according to the first R-TWT SP of the neighboring AP.

The second R-TWT SP and the first R-TWT SP do not overlap.

The first STA is associated with the first AP through at least one first link.

Specifically, the first STA may perform the low-latency service transmission via at least one first link within the second R-TWT SP according to the second link supported by the first R-TWT SP for the low-latency service transmission.

In a case that the first AP is an independent AP, and the first STA is an independent STA, an affiliate STA of a Non-AP MLD, or a Non-AP MLD, the first AP and the first STA are associated through one communication link. The first AP and the first STA may perform the low-latency service transmission within the second R-TWT SP through this communication link.

In a case that the first AP is an AP MLD, and the first STA is an independent STA or an affiliate STA of a Non-AP MLD, the first AP and the first STA are associated through one communication link. The first AP and the first STA may perform the low-latency service transmission within the second R-TWT SP through this communication link.

When the first AP is an AP MLD, and the first STA is a Non-AP MLD, the first AP and the first STA may be associated through at least one communication link. The first AP and the first STA may perform the low-latency service transmission within the second R-TWT SP through at least one of these communication links.

The communication link used by the first AP and the first STA for the low-latency service transmission within the second R-TWT SP is the first link.

In the method for the low-latency service transmission applied to the first STA provided by the embodiments of the present disclosure, each first link used by the first STA for the low-latency service transmission is either any communication link from at least one second link, or a NSTR link, eMLSR link, or eMLMR link with any second link.

Each second link is the communication link supported by the first R-TWT SP for the low-latency service transmission. The communication link supported by the first R-TWT SP for the low-latency service transmission is the second link. When the first R-TWT SP is applied to a single link, the first R-TWT SP supports one second link for the low-latency service transmission. When the first R-TWT SP is applied to multiple links, the first R-TWT SP supports a plurality of second communication links for the low-latency service transmission.

In some embodiments, each first link may also be any other communication link except for each second link.

For example, if the communication links supported by the first R-TWT SP for the low-latency service transmission are link1, link2, and link3, for any first link, the first link may be any one of link1, link2, or link3, or any other link except for link1, link2, and link3, or link4 (where link4 is the NSTR link, eMLSR link, or eMLMR link with any second link of link1, link2, or link3).

Based on this, the first STA may perform the low-latency service transmission within the second R-TWT SP through at least one first link.

As an example, when the first R-TWT SP supports one communication link for the low-latency service transmission, i.e., in a case that the first R-TWT SP is applied to a single link, when the first STA performs low-latency service transmission through the communication link, since the first R-TWT SP and the second R-TWT SP do not overlap, the first STA may transmit the low-latency service before the first R-TWT SP starts through the communication link.

As an example, when the first R-TWT SP supports the plurality of communication links (assuming link5 and link6) for the low-latency service transmission, i.e., in a case that the first R-TWT SP is applied to multiple links, when the communication link associated with the first STA does not include the communication link that is a NSTR link with link5, and the first STA performs the low-latency service transmission through link5, since the first R-TWT SP and the second R-TWT SP do not overlap, the first STA may transmit the low-latency service through link5 before the first R-TWT SP starts.

When there is a communication link (such as link 7) that is a NSTR link with link 6 in the communication link associated with the first STA, and the first STA performs the low-latency service transmission through link 7, since the first R-TWT SP and the second R-TWT SP do not overlap, the first STA may transmit the low-latency service through link 7 before the start of the first R-TWT SP, thus avoiding interference with the low-latency service transmission on link 6 of the neighboring AP of the first AP when transmitting the low-latency service through link 7 within the first R-TWT SP.

In the method for the low-latency service transmission applied to the first STA provided by the embodiments of the present disclosure, when the first R-TWT SP supports the plurality of communication links for the low-latency service transmission, the method further includes:
acquiring service-to-link (TID-to-link) mapping information corresponding to the first R-TWT SP from the first AP;
determining a plurality of second links supported by the first R-TWT SP for the low-latency service transmission according to the TID-to-link mapping information corresponding to the first R-TWT SP.

The first STA may determine the communication link corresponding to the low-latency service transmission supported by the first R-TWT SP according to the TID-to-link mapping information corresponding to the first R-TWT SP, and determine it as the second link for the low-latency service transmission supported by the first R-TWT SP.

When the first AP acquires the first R-TWT SP of the neighboring AP, the information field carrying the first R-TWT SP also includes first indication information, where the first indication information indicates that the first R-TWT SP supports the plurality of communication links for the low-latency service transmission.

For example, the information field carrying the first R-TWT SP may also include an aligned field, when a value of the aligned field is 1 (first indication information), it indicates that the first R-TWT SP supports the plurality of communication links for the low-latency service transmission.

In some embodiments, after the neighboring AP shares the first R-TWT SP, the neighboring AP may also send the first indication information to the first AP, which indicates that the first R-TWT SP supports the plurality of communication links for the low-latency service transmission. The manner by which the first AP acquires the first indication information is the same as the manner by which the first AP acquires the first R-TWT SP from the neighboring AP.

In a case that the first AP receives the first indication information, the first AP acquires the TID-to-link mapping information corresponding to the first R-TWT SP from the neighboring AP. In some embodiments, the information field used to carry the first R-TWT SP may include the TID-to-link mapping information corresponding to the first R-TWT SP, where the first AP, when acquiring the first R-TWT SP from the neighboring AP, may also acquire the TID-to-link mapping information corresponding to the first R-TWT SP simultaneously.

Based on this, the first frame may include the TID-to-link mapping information corresponding to the first R-TWT SP, or the first STA may receive a second frame sent by the first AP, where the second frame carries the TID-to-link mapping information corresponding to the first R-TWT SP.

In the method for the low-latency service transmission applied to the first STA provided by the embodiments of the present disclosure, when the first R-TWT SP supports the plurality of communication links for the low-latency service transmission, the first frame also includes first indication information, where the first indication information indicates that the first R-TWT SP supports the plurality of communication links for the low-latency service transmission.

When the second R-TWT SP supports the plurality of communication links for the low-latency service transmission, the first frame also includes second indication information, where the second indication information indicates that the second R-TWT SP supports the plurality of communication links for the low-latency service transmission.

The information field, used to carry the first R-TWT SP, of the first frame also includes first indication information, the first indication information indicates that the first R-TWT SP supports the plurality of communication links for the low-latency service transmission. For example, the information field used to carry the first R-TWT SP may also include an aligned field, when the value of the aligned field is 1 (first indication information), it's used to indicate that the first R-TWT SP supports the plurality of communication links for the low-latency service transmission.

Similarly, the information field, used to carry the second R-TWT SP, of the first frame also includes second indication information, the second indication information indicates that the second R-TWT SP supports the plurality of communication links for the low-latency service transmission. For example, the information field used to carry the second R-TWT SP may also include an aligned field, when the value of the aligned field is 1 (second indication information), it is used to indicate that the second R-TWT SP supports the plurality of communication links for the low-latency service transmission.

Based on this, the first AP may also indicate through the first frame whether the first R-TWT SP and the second R-TWT SP support the plurality of communication links for the low-latency service transmission to the STA.

In the method for the low-latency service transmission applied to the first STA provided by the embodiments of the present disclosure, it further includes:
suspending, within the first R-TWT SP, a backoff counter generated by each first link from counting.

That is, within the first R-TWT SP, the first STA does not decrement the number of the backoff counter generated by each first link.

In some embodiments, for each first link, when the first STA performs the low-latency service transmission through the first link within the first R-TWT SP, the first STA also suspends the counting of the backoff counter generated by the third link, which is the NSTR link, eMLSR link, or eMLMR link with the first link, within the first R-TWT SP.

In some embodiments, the first STA may also suspend the counting of the backoff counter generated by each first link within the second R-TWT SP.

As an example, for any first link used by the first AP and first STA for the low-latency service transmission within the second R-TWT SP, if the first link is the same as any second link supported by the first R-TWT SP for the low-latency service transmission, or is a NSTR link, eMLSR link, or eMLMR link with the second link, and since the first R-TWT SP and second R-TWT SP do not overlap, the first STA terminates the low-latency service transmission before the first R-TWT SP arrives.

Within the first R-TWT SP, the first STA suspends the counting of the backoff counter generated by each first link. If the first AP and the first STA are associated through a plurality of communication links, then, within the first R-TWT SP, when the first STA performs the low-latency service transmission through each first link, the first STA also suspends the counting of the backoff counter generated by each third link in the communication links between the first AP and the first STA, and the third link is a NSTR link, eMLSR link, or eMLMR link with each first link.

Based on the method for the low-latency service transmission provided by the embodiments of the present disclosure, after the first AP acquires the first R-TWT SP of the neighboring AP, the first AP may plan the second R-TWT SP of the first AP, such that the second R-TWT SP and the first R-TWT SP do not overlap. Furthermore, the embodiments of the present disclosure further provide how to perform the low-latency service transmission by the first AP and the first STA associated with the first AP, in the case that the first AP acquires the first R-TWT SP of the neighboring AP.

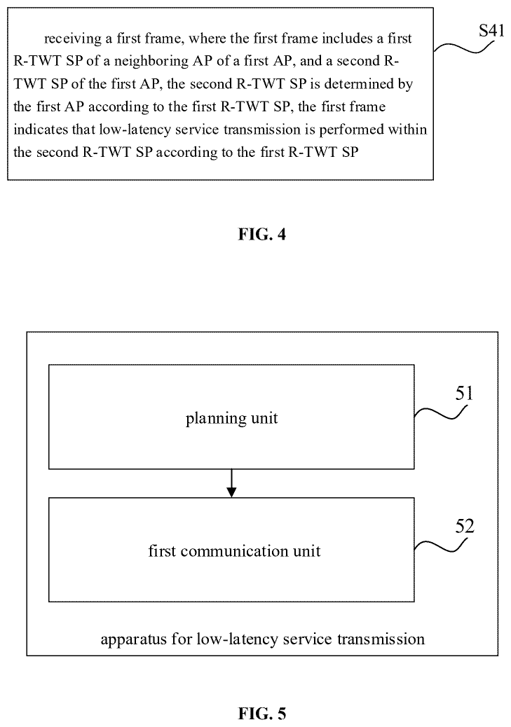

As shown in FIG. 5, the embodiments of the present disclosure provide an apparatus for the low-latency service transmission, and the apparatus includes:
a planning unit 51, configured to determine the second R-TWT SP according to a first Restricted Target Wake Time Service Period R-TWT SP of a neighboring AP;
a first communication unit 52, configured to send a first frame, where the first frame includes the first R-TWT SP and the second R-TWT SP, and the first frame indicates that low-latency service transmission is performed within the second R-TWT SP according to the first R-TWT SP.

In some embodiments, in the embodiments of the present disclosure, the above first communication unit 51 is also configured to:
perform the low-latency service transmission via at least one first link within the second R-TWT SP according to the first R-TWT SP, where the second R-TWT SP and the first R-TWT SP do not overlap.

In some embodiments, in the embodiments of the present disclosure, each first link is either any communication link from at least one second link, or is a Non-Simultaneous Transmit and Receive (NSTR) link with any second link;

each second link is a communication link supported by the first R-TWT SP for the low-latency service transmission.

In some embodiments, in the embodiments of the present disclosure, when the first R-TWT SP supports the plurality of communication links for the low-latency service transmission, the above first communication unit 51 is also configured to:

acquire the TID-to-link mapping information corresponding to the first R-TWT SP from the neighboring AP;

The above planning unit 51 is also configured to:
determine a plurality of second links supported by the first R-TWT SP for the low-latency service transmission according to the TID-to-link mapping information.

In some embodiments, in the embodiments of the present disclosure, when the first R-TWT SP supports the plurality of communication links for the low-latency service transmission, the first frame further includes first indication information, where the first indication information indicates that the first R-TWT SP supports the plurality of communication links for the low-latency service transmission;

when the second R-TWT SP supports the plurality of communication links for the low-latency service transmission, the first frame further includes second indication information, where the second indication information indicates that the second R-TWT SP supports the plurality of communication links for the low-latency service transmission.

In some embodiments, in the embodiments of the present disclosure, the above planning unit 51 is also configured to:
suspend a backoff counter generated by each first link from counting within the first R-TWT SP.

In some embodiments, in the embodiments of the present disclosure, the first frame is a beacon frame, a probe response frame, or an association response frame.

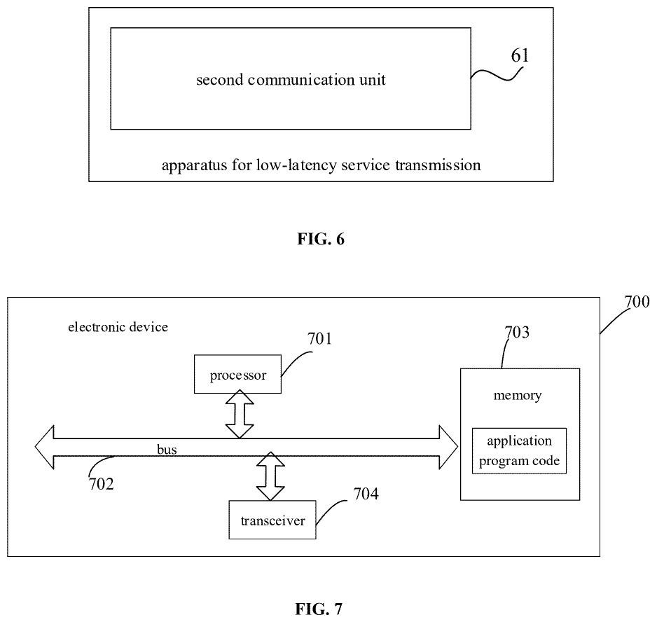

As shown in FIG. 6, the embodiments of the present disclosure provide an apparatus for the low-latency service transmission, and the apparatus includes:
a second communication unit 61, configured to receive a first frame, where the first frame includes a first R-TWT SP of a neighboring AP of a first AP and a second R-TWT SP of the first AP, the second R-TWT SP is determined by the first AP according to the first R-TWT SP. The first frame indicates that low-latency service transmission is performed within the second R-TWT SP according to the first R-TWT SP.

In some embodiments, in the embodiments of the present disclosure, the above second communication unit 61 is also configured to:
perform the low-latency service transmission via at least one first link within the second R-TWT SP according to the first R-TWT SP, where the second R-TWT SP and the first R-TWT SP do not overlap.

In some embodiments, in the embodiments of the present disclosure, each first link is either any communication link from at least one second link, or a Non-Simultaneous Transmit and Receive (NSTR) link with any second link;

each second link is a communication link supported by the first R-TWT SP for the low-latency service transmission.

In some embodiments, in the embodiments of the present disclosure, when the first R-TWT SP supports a plurality of communication links for the low-latency service transmission, the above second communication unit 61 is also configured to:
acquire TID-to-link mapping information corresponding to the first R-TWT SP from the first AP;
determine a plurality of second links supported by the first R-TWT SP for the low-latency service transmission according to the TID-to-link mapping information.

In some embodiments, in the embodiments of the present disclosure, when the first R-TWT SP supports a plurality of communication links for the low-latency service transmission, the first frame further includes first indication information, where the first indication information indicates that the first R-TWT SP supports the plurality of communication links for the low-latency service transmission;

when the second R-TWT SP supports the plurality of communication links for the low-latency service transmission, the first frame further includes second indication information, where the second indication information indicates that the second R-TWT SP supports the plurality of communication links for the low-latency service transmission.

In some embodiments, in the embodiments of the present disclosure, the above second communication unit 61 is also configured to:
suspend a backoff counter generated by each first link from counting within the first R-TWT SP.

In some embodiments, in the embodiments of the present disclosure, the first frame is a beacon frame, a probe response frame, or an association response frame.

The embodiments of the present disclosure also provide an electronic device, as shown in FIG. 7. The electronic device 700 shown in FIG. 7 includes: a processor 701 and a memory 703. The processor 701 and the memory 703 are connected, such as by a bus 702. In some embodiments, the electronic device 700 may also include a transceiver 704. It should be noted that, in practical applications, the transceiver 704 is not limited to one, and the structure of the electronic device 700 does not constitute a limitation to the embodiments of the present disclosure.

The memory 703 is configured to store an application program code for executing the embodiments of the present disclosure, and is controlled by the processor 701 to execute. When the electronic device 700 serves as the first AP, the processor 701 executes the application program code stored in the memory 703 to implement the method for the low-latency service transmission applied to the first AP provided by the embodiments of the present disclosure. When the electronic device 700 serves as the first STA, the processor 701 executes the application program code stored in the memory 703 to implement the method for the low-latency service transmission applied to the first STA provided by the embodiments of the present disclosure.

The bus 702 may include a path for transmitting information between the foregoing components. The bus 702 may be a peripheral component interconnect (PCI) bus, an extended industry standard architecture (EISA) bus, or the like. The bus 702 may be classified into an address bus, a data bus, a control bus, or the like. For ease of representation, only one thick line is used to represent the bus in FIG. 7, but this does not mean that there is only one bus or one type of bus.

The memory 703 may be a read only memory (ROM) or other types of static storage devices that can store static information and instructions, a random access memory (RAM) or other types of dynamic storage devices that can store information and instructions. The memory 703 may also be an electrically erasable programmable read only memory (EEPROM), a compact disc read only memory (CD-ROM) or other optical disc storages, an optical disc storage (including compressed optical discs, laser discs, optical discs, digital versatile discs, blue ray discs, etc.), a magnetic disk storage medium or other magnetic storage devices, or any other medium that can be used to carry or store desired program code in the form of instructions or data structures and can be accessed by a computer, but is not limited to this.

According to embodiments of the present disclosure, a computer-readable storage medium is provided, where a computer program is stored on the computer-readable storage medium. When the computer program runs on a computer, the computer is able to execute corresponding content in the foregoing method embodiments.

It should be understood that although the steps in the flowcharts of the drawings are sequentially displayed according to the indication of the arrows, these steps are not necessarily executed in sequence according to the order indicated by the arrows. Unless explicitly stated in the context, the execution of these steps is not strictly limited in sequence, and these steps may be executed in other orders. Moreover, at least some of the steps in the flowchart of the drawings may include a plurality of sub-steps or a plurality of stages. These sub-steps or stages are not necessarily executed and completed at the same time, but may be executed at different moments. The execution of these sub-steps or stages is not necessarily performed in sequence, but these sub-steps or stages may be executed in turn or alternately with at least a part of other steps or sub-steps or stages of other steps.

It should be noted that the computer-readable storage medium described in the present disclosure may be a computer-readable signal medium or a computer-readable storage medium or any combination of the foregoing. The computer-readable storage medium may be, for example, but not limited to, an electronic, magnetic, optical, electromagnetic, infrared, or semiconductor system, apparatus, or device, or any combination of the foregoing. A more specific example of the computer-readable storage medium may include, but is not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, the computer-readable storage medium may be any tangible medium containing or storing a program, and the program may be used by or used in combination with an instruction execution system, apparatus, or device. In the present disclosure, the computer-readable signal medium may include a data signal propagated in a baseband or as part of a carrier, in which computer-readable program code is carried. The propagated data signal may take a variety of forms, including but not limited to an electromagnetic signal, an optical signal, or any suitable combination of the foregoing. The computer-readable signal medium may also be any computer-readable storage medium other than a computer-readable storage medium, and the computer-readable signal medium may send, propagate, or transmit a program for use by or in connection with an instruction execution system, apparatus, or device. The program code included in the computer-readable storage medium may be transmitted by using any suitable medium, including but not limited to, an electric wire, an optical cable, a radio frequency (RF), or any suitable combination of the foregoing, etc.

The computer-readable storage medium may be included in the first AP or first STA, or may exist alone without being assembled into the first AP or first STA.

The computer-readable storage medium carries one or more programs, and when the one or more programs are executed by the first AP or first STA, the first AP or first STA is enabled to perform the method for low-latency service transmission shown in the foregoing embodiments.

According to an aspect of the present disclosure, there is provided a computer program product or a computer program. The computer program product or the computer program includes a computer instruction, and the computer instruction is stored in a computer-readable storage medium. A processor of the computer device reads the computer instruction from the computer-readable storage medium, and the processor executes the computer instruction, causing the computer device to perform the method for low-latency service transmission provided in the foregoing optional implementations.

Computer program code for performing the operations of the present disclosure may be written in one or more programming languages or a combination of the foregoing. The programming language includes object-oriented programming languages, such as Java, Smalltalk, C++, and further includes conventional procedural programming languages, such as the “C” language or similar programming languages. The program code may be executed entirely on the user computer, partially on the user computer, as a stand-alone software package, partially on the user computer and partially on a remote computer, or entirely on a remote computer or a server. In the case of involving a remote computer, the remote computer may be connected to the user computer through any kind of network, including a local area network (LAN) or a wide area network (WAN), or may be connected to an external computer (e.g. being connected through the Internet using an Internet service provider).

The flowchart and block diagrams in the drawings illustrate the architecture, function, and operation of possible implementations of systems, methods, and computer program products according to various embodiments of the present disclosure. In this regard, each block in the flowchart or block diagrams may represent a module, a program segment, or a portion of code, which includes one or more executable instructions for implementing the specified logical function. It should also be noted that, in some alternative implementations, the function noted in the block may occur in an order different from the order noted in the drawings. For example, two blocks shown in succession may, in fact, be executed substantially concurrently, or the blocks may sometimes be executed in a reverse order, which depends upon the function involved. It will also be noted that each block in the block diagrams and/or flowchart, and combinations of blocks in the block diagrams and/or flowchart, may be implemented by using special purpose hardware-based systems that perform the specified functions or operations, or may be implemented by using combinations of special purpose hardware and computer instructions.

The modules involved in the description of the embodiments of the present disclosure may be implemented by software, or may be implemented by hardware, where the name of the module does not constitute a limitation on the module itself in some cases. For example, the module A may also be described as “module A for performing operation B”.

A first aspect of the present disclosure provides a method for low-latency service transmission applicable to a first AP, and the method includes:
determining a second R-TWT SP according to a first Restricted Target Wake Time Service Period (R-TWT SP) of a neighboring AP;
sending a first frame, where the first frame includes the first R-TWT SP and the second R-TWT SP, and the first frame indicates that the low-latency service transmission is performed within the second R-TWT SP according to the first R-TWT SP.

A second aspect of the present disclosure provides a method for low-latency service transmission applicable to a first STA, and the method includes:
receiving a first frame, where the first frame includes a first R-TWT SP of a neighboring AP of a first AP and a second R-TWT SP of the first AP, the second R-TWT SP is determined by the first AP according to the first R-TWT SP, and the first frame indicates that low-latency service transmission is performed within the second R-TWT SP according to the first R-TWT SP.

A third aspect of the present disclosure further provides an apparatus for low-latency service transmission, and the apparatus includes:
a planning unit, configured to determine a second R-TWT SP according to a first R-TWT SP of a neighboring AP;
a first communication unit, configured to send a first frame, where the first frame includes the first R-TWT SP and the second R-TWT SP, and the first frame indicates that low-latency service transmission is performed within the second R-TWT SP according to the first R-TWT SP.

A fourth aspect of the present disclosure further provides an apparatus for low-latency service transmission, and the apparatus includes:
a second communication unit, configured to receive a first frame, where the first frame includes a first R-TWT SP of a neighboring AP of a first AP and a second R-TWT SP of the first AP, the second R-TWT SP is determined by the first AP according to the first R-TWT SP, and the first frame indicates that low-latency service transmission is performed within the second R-TWT SP according to the first R-TWT SP.

A fifth aspect of the present disclosure further provides an electronic device, including a memory, a processor, and a computer program stored in the memory and executable on the processor, where the processor, when executing the program, implements any of the method for low-latency service transmission provided in the present disclosure.

The above description is only a description of the preferred embodiments of the present disclosure and the applied technical principles. It should be understood by those skilled in the art that the disclosed scope of the present disclosure is not limited to the technical solution formed by the specific combination of the above technical features, and should also cover other technical solutions formed by any combination of the above technical features or their equivalent features without departing from the concept disclosed above, such as the technical solutions formed by replacing the above features with (but not limited to) technical features with similar functions disclosed in the present disclosure.

1. A method for low-latency service transmission, comprising:
determining, by a first Access Point (AP) and according to a first Restricted Target Wake Time Service Period (R-TWT SP) of a neighboring AP, a second R-TWT SP; and
sending, by the first AP, a first frame, wherein the first frame comprises the first R-TWT SP and the second R-TWT SP, and the first frame indicates that low-latency service transmission is performed within the second R-TWT SP according to the first R-TWT SP.

2. The method according to claim 1, further comprising:
performing, according to the first R-TWT SP, the low-latency service transmission via at least one first link within the second R-TWT SP, wherein the second R-TWT SP and the first R-TWT SP do not overlap.

3. The method according to claim 2, wherein each first link is either any communication link from at least one second link, or a Non-Simultaneous Transmit and Receive (NSTR) link with any second link;
wherein each second link is a communication link supported by the first R-TWT SP for the low-latency service transmission.

4. The method according to claim 3, wherein in a case where the first R-TWT SP supports a plurality of communication links for the low-latency service transmission, the method further comprises:
acquiring, from the neighboring AP, Traffic Identifier-to-Link Mapping (TID-to-link mapping) information corresponding to the first R-TWT SP; and
determining, according to the TID-to-link mapping information, a plurality of second links supported by the first R-TWT SP for the low-latency service transmission.

5. The method according to claim 1, wherein in a case where the first R-TWT SP supports a plurality of communication links for the low-latency service transmission, the first frame further comprises first indication information, wherein the first indication information indicates that the first R-TWT SP supports the plurality of communication links for the low-latency service transmission;
in a case where the second R-TWT SP supports the plurality of communication links for the low-latency service transmission, the first frame further comprises second indication information, and the second indication information indicates that the second R-TWT SP supports the plurality of communication links for the low-latency service transmission.

6. The method according to claim 2, further comprising:
suspending, within the first R-TWT SP, a backoff counter generated by each first link from counting.

7. A method for low-latency service transmission, comprising:
receiving, by a first STA, a first frame, wherein the first frame comprises a first R-TWT SP of a neighboring AP of a first AP, and a second R-TWT SP of the first AP, wherein the second R-TWT SP is determined by the first AP according to the first R-TWT SP, and wherein the first frame indicates that low-latency service transmission is performed within the second R-TWT SP according to the first R-TWT SP.

8. The method according to claim 7, further comprising:
performing, according to the first R-TWT SP, the low-latency service transmission via at least one first link within the second R-TWT SP, wherein the second R-TWT SP and the first R-TWT SP do not overlap.

9. The method according to claim 8, wherein each first link is either any communication link from at least one second link, or a Non-Simultaneous Transmit and Receive NSTR link with any second link;
wherein each second link is a communication link supported by the first R-TWT SP for the low-latency service transmission.

10. The method according to claim 9, wherein in a case where the first R-TWT SP supports a plurality of communication links for the low-latency service transmission, the method further comprises:
acquiring, from the first AP, TID-to-link mapping information corresponding to the first R-TWT SP; and
determining, according to the TID-to-link mapping information, a plurality of second links supported by the first R-TWT SP for the low-latency service transmission.

11. The method according to claim 7, wherein in a case where the first R-TWT SP supports a plurality of communication links for the low-latency service transmission, the first frame further comprises first indication information, wherein the first indication information indicates that the first R-TWT SP supports the plurality of communication links for the low-latency service transmission;
in a case where the second R-TWT SP supports the plurality of communication links for the low-latency service transmission, the first frame further comprises second indication information, and the second indication information indicates that the second R-TWT SP supports the plurality of communication links for the low-latency service transmission.

12. The method according to claim 8, further comprising:
suspending, within the first R-TWT SP, a backoff counter generated by each first link from counting.

13.-14. (canceled)

15. An electronic device, comprising a memory, a processor, and a computer program stored in the memory and executable on the processor, wherein the processor, when executing the program, is configured to:
determine, according to a first R-TWT SP of a neighboring AP, a second R-TWT SP; and
send a first frame, wherein the first frame comprises the first R-TWT SP and the second R-TWT SP, wherein the first frame indicates that low-latency service transmission is performed within the second R-TWT SP according to the first R-TWT SP.

16. (canceled)

17. The electronic device according to claim 15, wherein the processor is further configured to:
perform, according to the first R-TWT SP, the low-latency service transmission via at least one first link within the second R-TWT SP, wherein the second R-TWT SP and the first R-TWT SP do not overlap.

18. The electronic device according to claim 17, wherein each first link is either any communication link from at least one second link, or a Non-Simultaneous Transmit and Receive (NSTR) link with any second link;
wherein each second link is a communication link supported by the first R-TWT SP for the low-latency service transmission.

19. The electronic device according to claim 18, wherein in a case where the first R-TWT SP supports a plurality of communication links for the low-latency service transmission, the processor is configured to:
acquire, from the neighboring AP, TID-to-link mapping information corresponding to the first R-TWT SP; and
determine, according to the TID-to-link mapping information, a plurality of second links supported by the first R-TWT SP for the low-latency service transmission.

20. The electronic device according to claim 15, wherein in a case where the first R-TWT SP supports a plurality of communication links for the low-latency service transmission, the first frame further comprises first indication information, wherein the first indication information indicates that the first R-TWT SP supports the plurality of communication links for the low-latency service transmission;
in a case where the second R-TWT SP supports the plurality of communication links for the low-latency service transmission, the first frame further comprises second indication information, and the second indication information indicates that the second R-TWT SP supports the plurality of communication links for the low-latency service transmission.

21. The electronic device according to claim 17, wherein the processor is further configured to:
suspend, within the first R-TWT SP, a backoff counter generated by each first link from counting.

22. An electronic device, comprising a memory, a processor, and a computer program stored in the memory and executable on the processor, wherein the processor, when executing the program, implements the method according to claim 7.

23. The electronic device according to claim 22, wherein the processor is further configured to:
perform, according to the first R-TWT SP, the low-latency service transmission via at least one first link within the second R-TWT SP, wherein the second R-TWT SP and the first R-TWT SP do not overlap.
